(19) United States
(12) Patent Application Publication
(10) Pub. No.: US 2006/0207342 A1
(43) Pub. Date: Sep. 21, 2006

(54) Apparatus and method for obtaining press measurements

(76) Inventors: Walter J. Pukanich, Drayton Valley (CA); George I. Sztym, Rocky Mountain Home (CA); Daren R. Hesse, Drayton Valley (CA)

Correspondence Address: WEYERHAEUSER COMPANY;INTELLECTUAL PROPERTY DEPT., CH 1J27, P.O. BOX 9777, FEDERAL WAY, WA, 98063, US

(21) Appl. No.: 11/081,317

(22) Filed: Mar. 16, 2005

(51) Int. Cl. G01N 3/08

(52) U.S. Cl. 73/818

(57) ABSTRACT

An apparatus and a method for obtaining press measurements are provided. The apparatus has a cylinder attached to a frame wherein a casing is positioned along a length of the frame. A bracket carrier is fastened onto the casing and moves along a length of the casing from a first end of the frame to a second end. A probe is attached to the bracket carrier and moves as the bracket carrier moves. The probe moves from the first end of the frame to the second end. As the probe returns to the first end, a dispenser deposits a release agent onto the probe to prevent the probe from bonding to press elements, such as platens, strands, or the like.

### FIELD OF THE INVENTION

This invention relates generally to an apparatus and method for obtaining press measurements. More specifically, the apparatus has a probe which is delivered to a press during compression of layers of, for example, an oriented strand board panel. The delivery means is automated.

### BACKGROUND OF THE INVENTION

Wood products, such as oriented strand board panels, consist of several layers of wood strands. A first layer is formed by depositing numerous strands onto a mat. The first layer and mat are then moved to a second location where a second set of strands are deposited on the first layer. Once all layers of strands have been deposited onto the mat, the strands are placed within a press. Heat and pressure are then applied to the strands to form a finished product.

To maximize adhesion between the layers of strands, it is desirable to ascertain properties within the press, such as a temperature and/or a pressure within the press. Probes are typically inserted within the press during compression of the layers to obtain these properties. The probes are administered by an individual who usually stands next to the press during the compression and places the probe within the press. After the probe is withdrawn, the probe must be treated with a release agent to prevent the probe from bonding to materials within the press. Repeated insertion and withdrawal of the probe, as well as treatment of the probe with a release agent, are safety-related, tedious and labor-intensive tasks. Accordingly, a need exists for an apparatus and method for automatically introducing and withdrawing a probe into a press during a cycle.

### SUMMARY OF THE INVENTION

The present invention provides an apparatus and a method for obtaining press measurements. The apparatus has a probe which is positioned on a top surface of a frame. A cylinder is attached to the frame and a casing, or barrel, of the cylinder is positioned along a length of the frame. A bracket carrier is fitted onto the casing and moves along a length of the casing. The probe is attached to the bracket carrier and moves as the bracket carrier moves. The probe moves from a rear end of the apparatus to a front end. As the probe returns to the rear end, a dispenser deposits a release agent onto the probe to prevent the probe from bonding to press elements, such as platens, strands, or the like during a future insertion.

In an embodiment, the apparatus has a frame having a length between a front end and a rear end and a width defined between opposing sides. Walls extend from the opposing sides and define an interior surface. A cylinder is attached to the interior surface of the frame. The cylinder has a casing having a length defined between a first end and a second end. The first end is adjacent to the rear end of the frame and the second end is adjacent to the front end of the frame. The cylinder has a bracket carrier fitted onto the casing wherein the bracket carrier is movable along a length of the casing. A probe is positioned on a surface of one of the opposing walls. The probe is capable of measuring temperature and/or pressure of the materials within the press and is attached to the bracket carrier. Movement of the bracket carrier toward the front end of the frame causes movement of the probe toward the front end of the frame. A dispenser is located at the front end of the frame wherein the dispenser applies a release agent to the probe.

It is, therefore, an advantage of the present invention to provide an apparatus and a method for obtaining press measurements wherein the apparatus inserts the probe into the press in an automated manner.

It is a further advantage of the present invention to provide an apparatus and a method for obtaining press measurements wherein the apparatus and method reduce an amount of labor and/or safety concerns associated with obtaining the press measurements.

Additional features and advantages of the present invention are described in, and will be apparent from, the detailed description of the present embodiments and from the drawings.

### BRIEF DESCRIPTION OF THE DRAWINGS

The embodiments of the present invention are described in detail below with reference to the following drawings.

FIG. 1 is a side view of an apparatus for obtaining press measurements in an embodiment of the present invention;

FIG. 2 is a partial side view of a rear end of the apparatus of FIG. 1;

FIG. 3 is a partial side view of a front end of the apparatus of FIG. 1;

FIGS. 4A, 4B, 4C and 4D are side views of the apparatus of FIG. 1 in which a probe moves from the rear end to the front end and returns to the rear end;

FIG. 5 is a side view of the apparatus of FIG. 1 illustrating a side of the apparatus opposite to the side depicted in FIG. 1; and

FIG. 6 is a perspective view of the apparatus of FIG. 1 attached to a press.

### DETAILED DESCRIPTION OF THE INVENTION

The present invention provides an apparatus and a method for obtaining press measurements. The apparatus has a probe which is positioned on a top surface of a frame. A cylinder is attached to the frame wherein a casing or barrel is positioned along a length of the frame. A bracket carrier is wrapped around the casing and moves along a length of the casing. The probe is attached to the bracket carrier and moves as the bracket carrier moves. The probe moves from a rear end of the apparatus to a front end. As the probe returns to the rear end, a dispenser deposits a release agent onto the probe to prevent the probe from bonding to press elements, such as platens, strands, or the like during a future insertion.

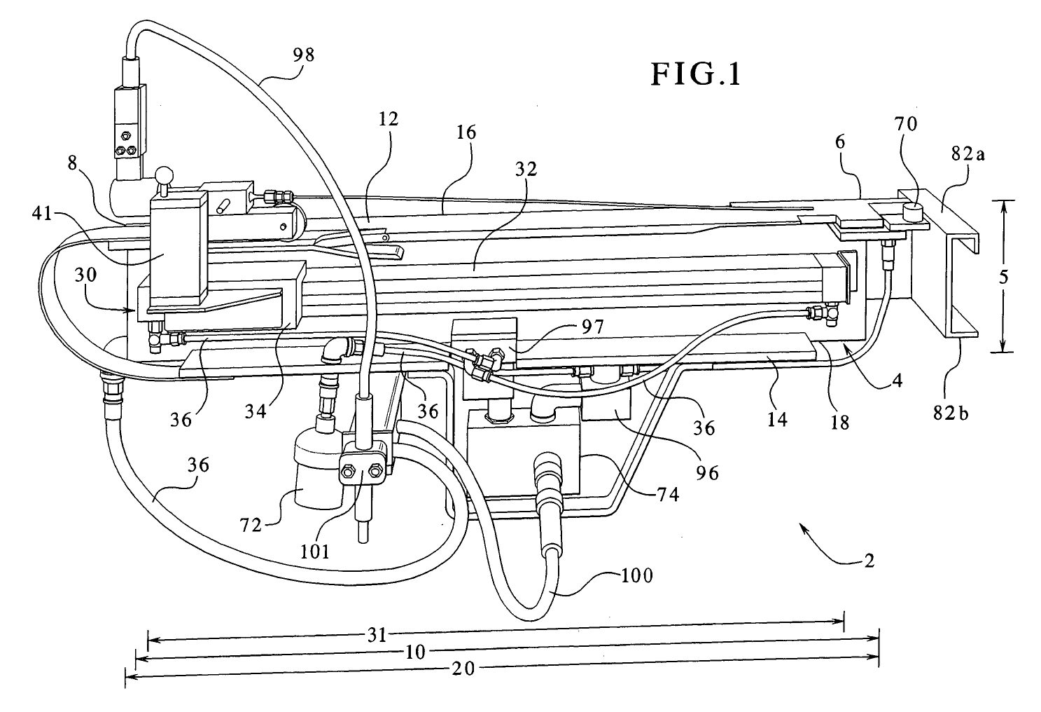

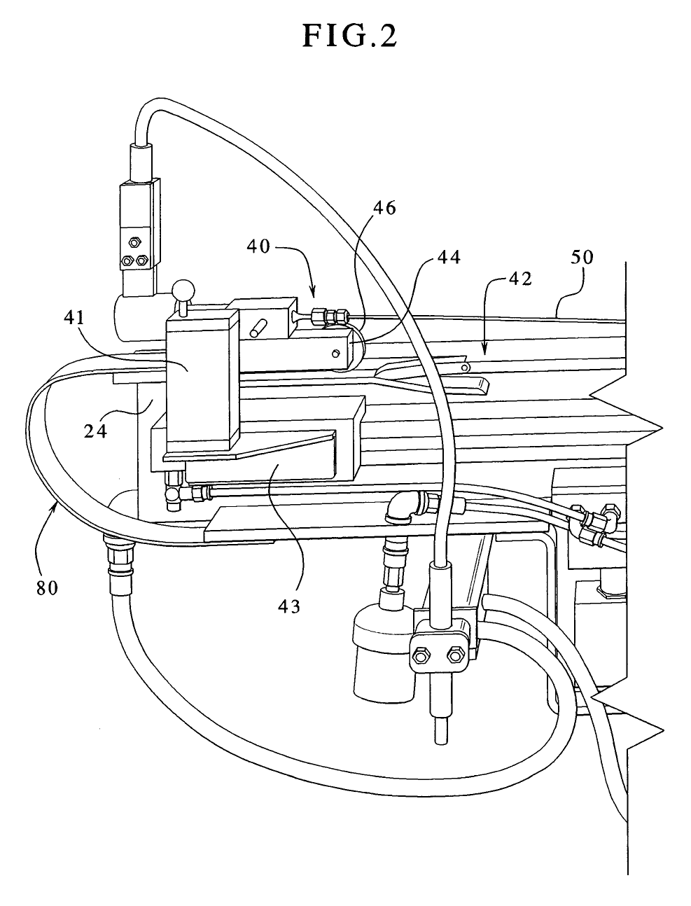

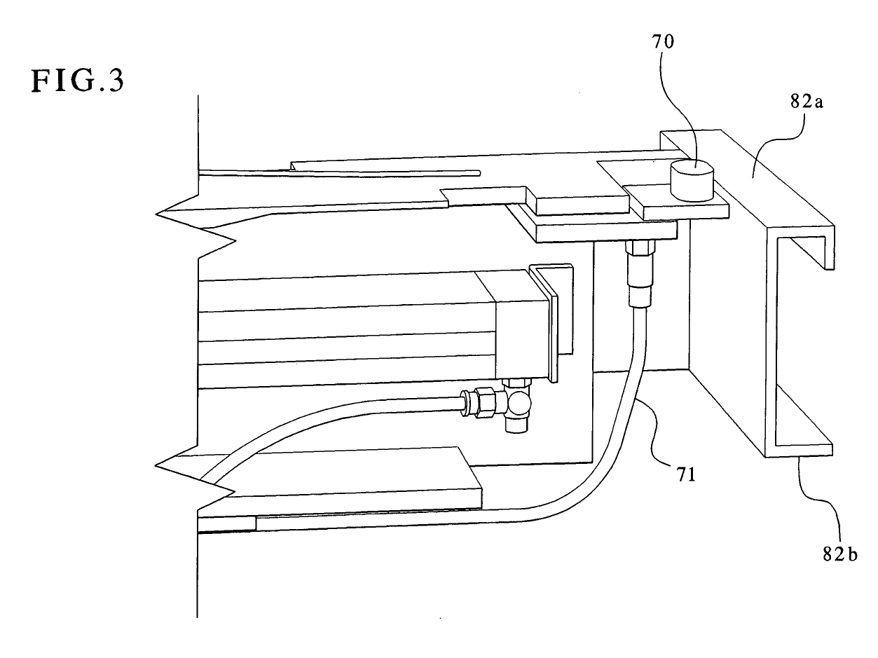

Referring now to the drawings wherein like numerals refer to like parts, FIG. 1 illustrates an apparatus 2 which has a frame 4 extending from a front end 6 to a rear end 8. The frame 4 may be constructed from metal, wood, plastic, or the like. The frame 4 may have a length 10 in a range from 25 inches to 35 inches and a width 5 in a range from 3 inches to 12 inches. In addition, the frame 4 may have walls 12, 14 which extend from sides 16, 18, respectively. The walls 12, 14 have a length 20, 22 in a range from 20 inches to 35 inches and define an interior area 24 having an interior surface 26.

A cylinder 30 may be attached to the interior surface 26 via, for example, fasteners, adhesives or other means. The cylinder 30 may have a length 31 in a range from 15 inches to 30 inches. The cylinder 30 has a shaft or casing 32 which may be constructed from plastic, metal, or a like material. A bracket carrier 34 may be fitted onto the casing 32. The bracket carrier 34 may be moved via a sliding motion along the length 31 of the cylinder 30. Various tubes 36 may be attached to the cylinder 30 to facilitate movement of the bracket carrier 34 according to conventional cylinder mechanisms. In addition, an air valve 97 may assist in controlling air flow to facilitate movement of the bracket carrier 34 according to known cylinder mechanisms. Moreover, a power source (not shown) may be in connection with the cylinder 30 via wires (not shown) to enable movement of the cylinder 30.

A sliding assembly 40 may be connected to the bracket carrier 34 and may be situated on a surface 42 of the wall 12. To this end, a probe height adjuster block 41 may be provided which may be connected to a bracket 43 attached to the bracket carrier 34. The sliding assembly 40 may have a frame 44 having a roller 46 attached to the frame 44. The frame 44 may be constructed from wood, plastic, metal, or the like. The roller 46 allows the sliding assembly 40 to move across the surface 42. Accordingly, when the bracket carrier 34 is moved from the rear end 8 of the frame 4 to the front end 6, the sliding assembly 40 is moved along the top surface 42. The probe 50 may remain elevated in order to enter, for example, a center of a mat. Likewise, when the bracket carrier 34 is moved from the front end 6 to the rear end 8, the sliding assembly also moves in that direction. It is contemplated that the sliding assembly 40 may have any type of rolling/sliding mechanism, such as, for example, wheels or other device which may enable the sliding assembly 40 to move across the surface 42 of the wall 12.

A probe 50 may be positioned on the sliding assembly 40. The probe 50 may have a length 52 in a range from 15 inches to 30 inches. The probe 50 may have a cylindrical body 54 having sensors (not shown) embedded within the body 54 at an end 58. However, any shape is contemplated for the probe 50, such as, for example, conical, rectangular, a combination of these, or other practical geometries. The body 54 may be constructed from wood, metal, plastic, or the like. The sensors may detect and/or measure temperature, pressure, or various other properties which may, for example, be detected/measured within a press or within materials within a press. The probe 50 may be electrically connected via wiring 98 to a central processing unit (not shown) remotely located from the apparatus 2. The wiring 98 and/or tubes 36 may be supported by a clamping device 101 to provide stability.

A dispenser 70 may be associated with the frame 4 at the front end 6. The dispenser 70 may be connected via a tube 71 to a container 72 which stores a release agent, such as a soap or chemically similar substance. An electrical control box 74 may be connected to a lubing valve 96 which may be connected to the tube 71. The electrical control box 74 may enable transmission of the release agent from the container 72 to the dispenser 70 via the tube 71. An electrical line 100 may provide power to the electrical control box 74. In an embodiment, the dispenser 70 may be in connection with the central processing unit to deposit the release agent onto the probe 50 as, for example, the probe 50 travels from the front end 6 to the rear end 8. In another embodiment, the electrical control box 74 is in connection with the central processing unit. The dispenser 70 deposits the release agent to lubricate the probe 50 and prevent adhesion to a press, or contents within a press, upon subsequent iterations. Moreover, any adequate means for storage and/or delivery of release agent is contemplated, including, but not limited to, the use of various containers or storage devices, and the use of pumps, tubing or the like which may be attached to and/or connected with the apparatus 2.

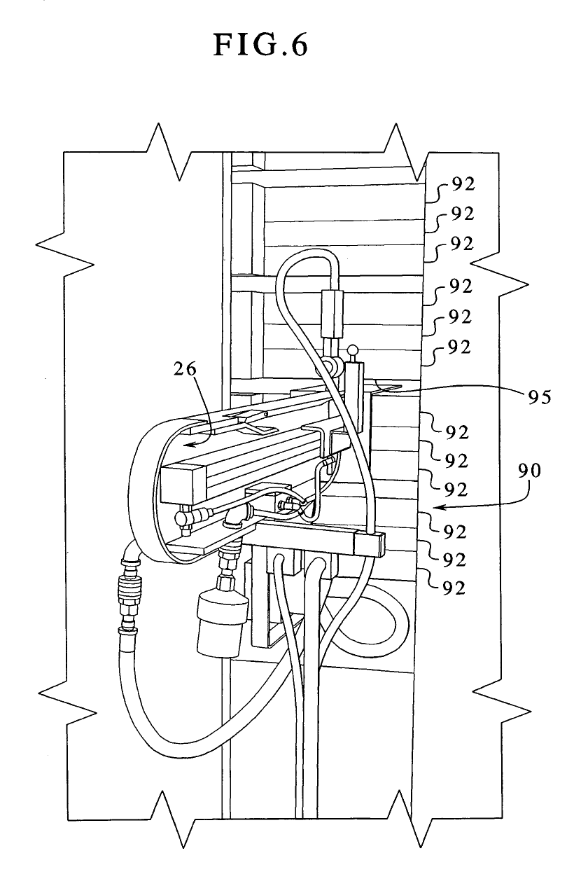

A handle 80 may be attached to the rear end 8 of the frame 4. The handle 80 may be constructed from wood, metal, plastic, or the like. The front end 6 of the frame 4 may have tabs 82a, 82b which may be constructed from metal, plastic, wood, or the like. In an embodiment, the tabs 82a, 82b may be L-shaped to enable the tabs 82a, 82b to secure to an edge of a press. Both the handle 80 and the tabs 82a, 82b may assist an individual in placing the apparatus 2 adjacent to a press. For example, the individual may grasp the handle 80 to lift the apparatus 2 and place the tab 82a, 82b within an opening or slot 95 typically present in a press 90 adjacent to platens 92, as illustrated in FIG. 6.

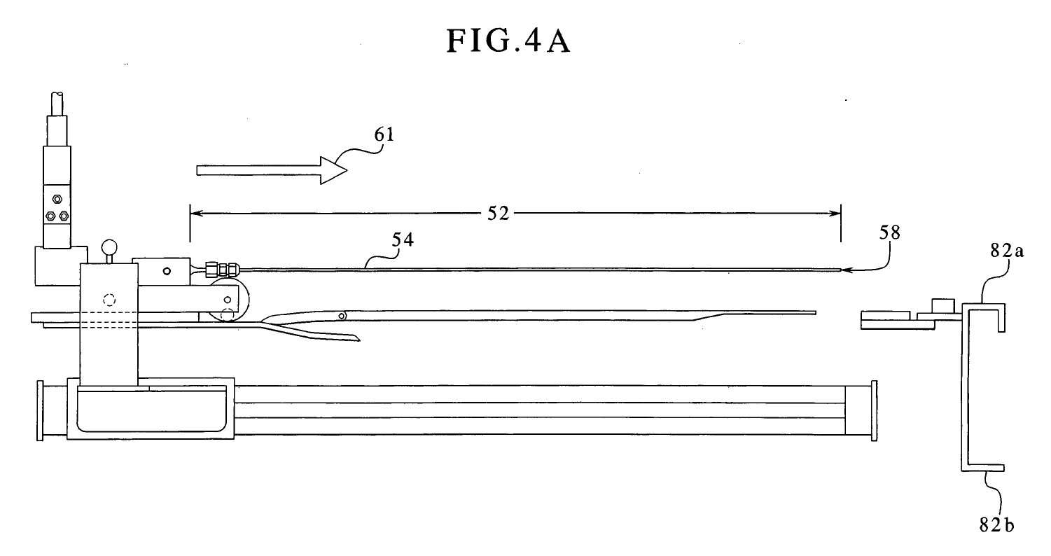

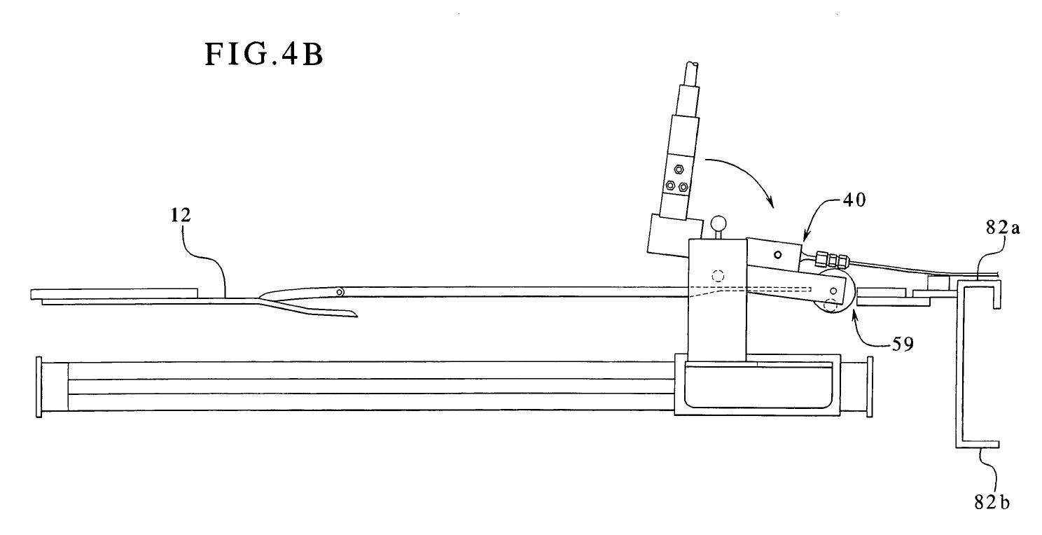

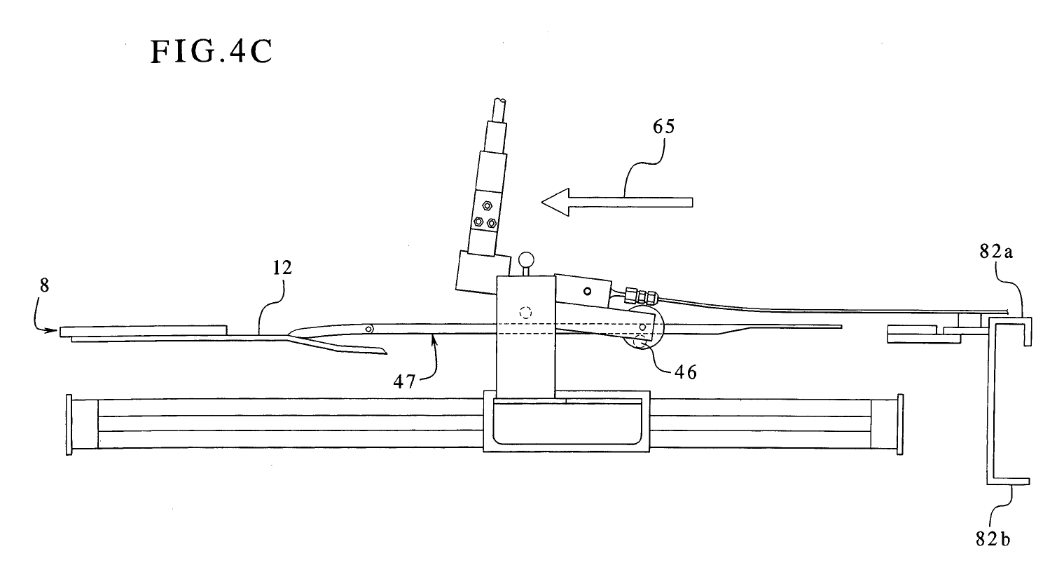

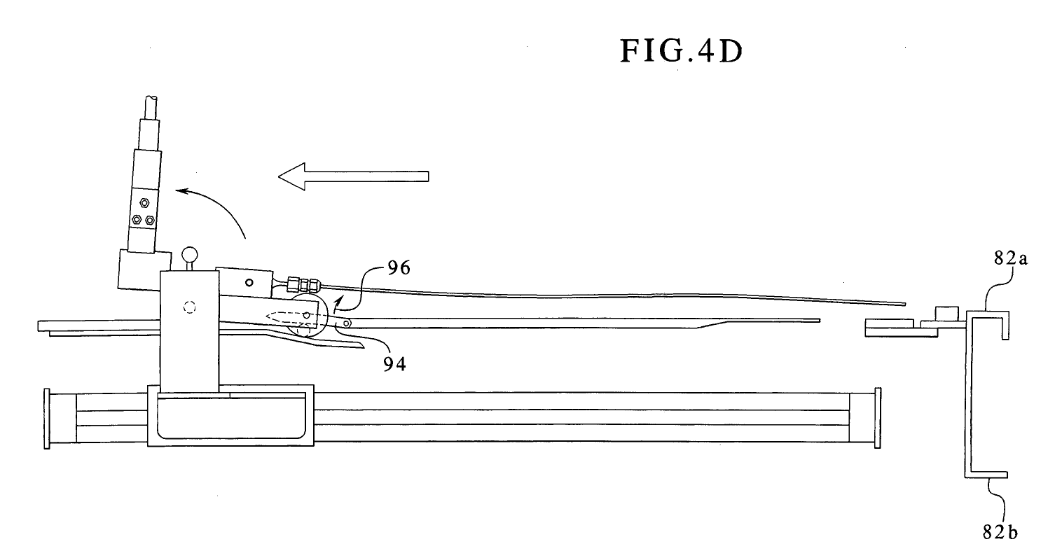

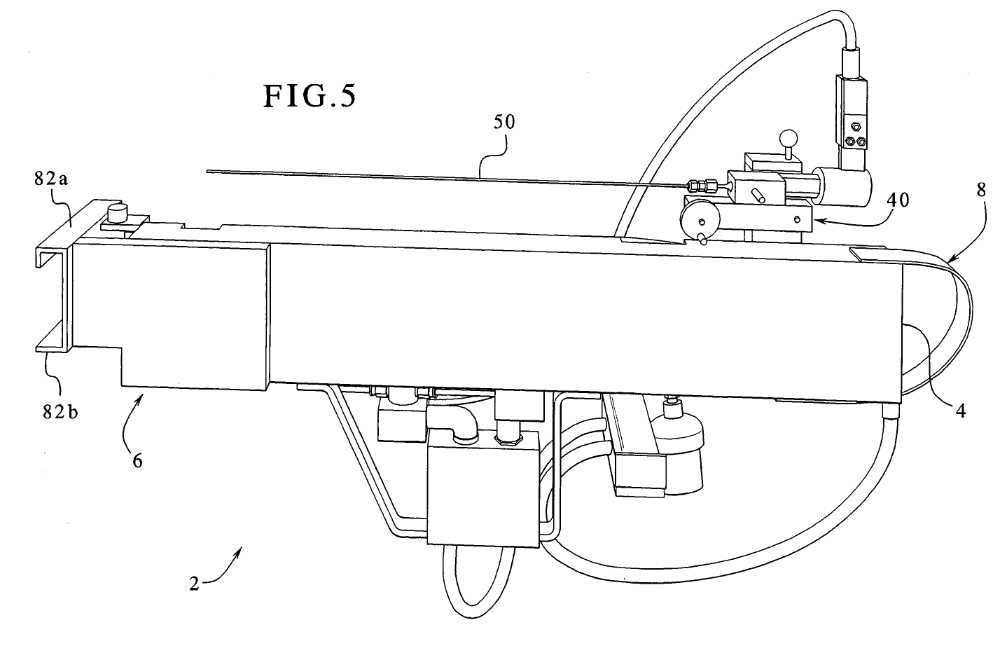

FIGS. 4A, 4B, 4C and 4D illustrate isolated components of the apparatus 2 to demonstrate the movement of the probe 50 from the rear end 8 to the front end 6 for insertion of the probe 50 within a press, as well as the return movement of the probe 50 towards the rear end 8 after insertion. More specifically, FIG. 4A illustrates the probe 50 near the rear end 8 prior to movement toward the front end 6, as indicated by arrow 61. The sliding assembly 40 may move in correlation to movement of the casing 32 along the cylinder 30. FIG. 4B illustrates the probe 50 positioned at the front end 6. While at the front end 6, the sliding assembly 40 may be lowered through an opening 59 in the wall 12. In an embodiment, lowering of the sliding assembly 40 may be caused by gravity. In another embodiment, the sliding assembly 40 may be inserted into a mat and may be lowered due to compression of the materials on the mat. However, it is contemplated that, in other embodiments, the sliding assembly 40 may be lowered mechanically. For example, the block 41 may be adjusted by twisting the knob 85 to tighten the brackets 87 to raise or lower the height of the block 41. This may then raise or lower the sliding assembly 40 with respect to the wall 12. Lowering of the sliding assembly 40 may enable the probe 50 to contact the dispenser 70 and allow the release agent to be deposited onto the probe 50. The release agent may prevent the probe 50 from becoming attached to platens, strands, debris, or other press elements.

FIG. 4C illustrates movement of the probe 50 toward the rear end 8 as indicated by arrow 65. The roller 46 may contact a bottom surface 47 of the wall 12 and may enable sliding or other similar movement of the sliding assembly 40 along the bottom surface 47. As the sliding assembly 40 approaches the rear end 8, the roller 46 may pass through a latch 94 attached to the wall 12, as illustrated in FIG. 4D. The latch 94 may be pivoted upward as indicated by arrow 96 to provide an opening through which the roller 46 passes. The roller 46 may then contact the surface 42 of the wall 12 and return to its initial, or starting, position.

The apparatus 2 of the present invention provides several advantages over prior methods of obtaining press measurements. For example, the apparatus 2 eliminates a need for an individual to manually administer and remove a probe from a press. The individual may simply attach the apparatus 2 to a slot adjacent the platens and operate the apparatus 2 from a remote location to insert and remove the probe 50. The probe measurements are transmitted to a remote location as well. The tab 82 enables the apparatus 2 to remain a fixed distance from the press and may ensure that the probe 50 is inserted at a uniform distance during each iteration. By implementing a cylinder, the apparatus 2 may ensure that the probe 50 is delivered in a uniform and reproducible manner. Moreover, it is contemplated that, in some embodiments, the probe 50 may be attached with a cylinder and may be moved along the cylinder without the use of a frame. That is, the apparatus 2 may not include a frame, yet other components, such as the dispenser and/or tabs, may be otherwise associated with the cylinder and may perform their intended functions.

While the embodiments of the invention have been illustrated and described, as noted above, many changes can be made without departing from the spirit and scope of the invention. Accordingly, the scope of the invention is not limited by the disclosure of the embodiments. Instead, the invention should be determined entirely by reference to the claims that follow.

What is claimed is:

1. An apparatus for obtaining press measurements comprising:
a frame having a length between a front end and a rear end and a width defined between opposing sides;
a cylinder attached with the frame wherein the cylinder has a casing having a length defined between a first end and a second end wherein the first end is adjacent to the rear end of the frame and wherein the second end is adjacent to the front end of the frame and wherein the cylinder has a bracket carrier fitted onto the casing wherein the bracket carrier is movable along a length of the casing;
a probe capable of measuring properties of materials within the press wherein the probe is attached with the bracket carrier and further wherein movement of the bracket carrier toward the front end of the frame causes movement of the probe toward the front end of the frame; and
a dispenser located at the front end of the frame wherein the dispenser applies a release agent to the probe.

2. The apparatus of claim 1 further comprising:
a sliding assembly between the probe and the wall wherein the sliding assembly moves along the wall when the bracket carrier is moved.

3. The apparatus of claim 1 further comprising:
an electrical control box in connection with the dispenser wherein the electrical control box controls a flow rate of the release agent.

4. The apparatus of claim 1 further comprising:
a container attached to the frame wherein the container is in connection with the dispenser and wherein the container stores the release agent.

5. The apparatus of claim 1 wherein the wall has an opening at the front end wherein the probe is lowered toward the opening when the probe is moved toward the front end.

6. The apparatus of claim 1 wherein the wall has a latch between the rear end and the front end wherein the latch is pivotable to create an opening in the wall.

7. An apparatus for obtaining press measurements comprising:
a frame having a length defined between a front end and a rear end;
a probe moveable across the frame wherein the probe moves from the rear end to the front end and returns to the rear end in a single iteration; and a dispenser attached with the frame wherein the dispenser applies a release agent to the probe during an iteration.

8. The apparatus of claim 7 further comprising:
a cylinder attached to the frame wherein movement of the cylinder causes movement of the probe along the frame.

9. The apparatus of claim 7 further comprising:
a container in connection with the dispenser wherein the container stores the release agent.

10. The apparatus of claim 7 further comprising:
a roller associated with the probe.

11. The apparatus of claim 7 further comprising:
an electrical control box in connection with the dispenser wherein the electrical control box controls an amount of release agent dispensed.

12. The apparatus of claim 7 further comprising:
an L-shaped tab extending from the front end of the frame.

13. The apparatus of claim 7 wherein the probe measures temperature within the press.

14. The apparatus of claim 7 wherein the probe measures pressure within the press.

15. A method for obtaining measurements within a press, the method comprising the steps of:
attaching a probe to a moving element of a cylinder wherein the moving element transverses between a first end of the cylinder and a second end of the cylinder;
positioning the cylinder adjacent to the press; and
changing a position of the moving element between the first end and the second end wherein the probe is moved towards the press.

16. The method of claim 15 further comprising the step of:
applying a release agent to the probe.
